(19) United States
(12) Patent Application Publication
(10) Pub. No.: US 2026/0163435 A1
(43) Pub. Date: Jun. 11, 2026

(54) MOTOR UNIT

(71) Applicant: TOYOTA JIDOSHA KABUSHIKI KAISHA, Toyota-shi (JP)

(72) Inventors: Kengo OHIRA, Toyota-shi (JP); Masahiro TANAKA, Nagoya-shi (JP); Masataka IWAMOTO, Toyota-shi (JP); Masayuki INADA, Okazaki-shi (JP)

(73) Assignee: TOYOTA JIDOSHA KABUSHIKI KAISHA, Toyota-shi (JP)

(21) Appl. No.: 19/390,884

(22) Filed: Nov. 17, 2025

(30) Foreign Application Priority Data
Dec. 10, 2024 (JP) 2024-215975

(51) Int. Cl. H02K 3/50; H02K 1/12

(52) U.S. Cl. CPC H02K 3/50; H02K 1/12; H02K 2203/09

(57) ABSTRACT

A motor unit may include: a first terminal located at a leading end of a motor busbar; a first guide member fixed to the first terminal and including a first guide surface; a second terminal fastened to the first terminal and including a contact surface for contact with the first terminal; a terminal block holding the second terminal; and a second guide member fixed to the second terminal and including a second guide surface. The first and the second guide surfaces may be configured to come into contact with each other as the first terminal approaches the second terminal in a direction parallel to the contact surface. Each of the first and the second guide surfaces may include a first profile that prohibits contact between the first and the second terminal at least when the first and the second terminals begin to face each other.

### CROSS REFERENCE TO RELATED APPLICATION

This application claims priority to Japanese Patent Application No. 2024-215975 filed on Dec. 10, 2024. The entire content of the priority application is incorporated herein by reference.

### TECHNICAL FIELD

The art disclosed herein relates to a motor unit.

### BACKGROUND ART

Japanese Patent Application Publication No. 2005-229755 describes a motor unit. In this motor unit, a first terminal is located at the leading end of a motor busbar. The first terminal of the motor is fastened to a second terminal at a terminal block fixed to a casing and contacts a contact surface of the second terminal. A power converter is electrically connected to the second terminal, and the motor is electrically connected to the power converter via the terminal block.

### SUMMARY

In motor units such as the one described above, it is preferable that the first terminal on the motor busbar be positioned relative to the second terminal at the terminal block fixed to the casing when the motor is attached to the casing. During the attachment, depending on the design of the motor unit, the first terminal at the motor busbar may approach the second terminal in a direction parallel to the contact surface of the second terminal. In such a case, the first terminal and the second terminal slide against each other, which may cause conductive particles from the first terminal and/or the second terminal. To avoid this, it is considered to provide a space between the first terminal and the second terminal. However, if a space is provided between the two terminals, the motor busbar may be deformed elastically when the first terminal is fastened to the second terminal, which may apply an undesired load to a stator coil connected to the motor busbar.

In view of the above, the disclosure herein provides a novel structure to fasten a first terminal at the motor busbar to a second terminal at a terminal block.

The technique disclosed herein is embodied as a motor unit. The motor unit may comprise a motor comprising a stator coil; a motor busbar connected to the stator coil; a first terminal located at a leading end of the motor busbar; a first guide member fixed to the first terminal and comprising a first guide surface; a second terminal fastened to the first terminal with a bolt and comprising a contact surface for contact with the first terminal; a terminal block holding the second terminal; and a second guide member fixed to the second terminal and comprising a second guide surface. The first guide surface and the second guide surface may be configured to come into contact with each other as the first terminal approaches the second terminal in a direction parallel to the contact surface. Each of the first guide surface and the second guide surface may comprise a first profile that prohibits contact between the first terminal and the second terminal at least when the first terminal and the second terminal begin to face each other.

### BRIEF DESCRIPTION OF DRAWINGS

FIG. 1 is a diagram showing a configuration of a motor unit according to a first embodiment.

FIG. 2 is a cross-sectional view of first and second terminals along a line II-II in FIG. 1.

FIG. 3 is an enlarged cross-sectional view of a portion III in FIG. 2.

FIG. 4 is a diagram showing the state before a terminal block is attached to a casing.

FIG. 5a is a cross-sectional view along a line Va-Va in FIG. 4, showing how a plurality of first terminals is connected to a plurality of second terminals.

FIG. 5b is a cross-sectional view along a line Va-Va in FIG. 4, showing how the plurality of first terminals is connected to the plurality of second terminals.

FIG. 5c is a cross-sectional view along a line Va-Va in FIG. 4, showing how the plurality of first terminals is connected to the plurality of second terminals.

FIG. 5d is a cross-sectional view along a line Va-Va in FIG. 4, showing how the plurality of first terminals is connected to the plurality of second terminals.

FIG. 5e is a cross-sectional view along a line Va-Va in FIG. 4, showing how the plurality of first terminals is connected to the plurality of second terminals.

FIG. 6 is a diagram showing a configuration of a motor unit according to a second embodiment.

### DETAILED DESCRIPTION

In a first aspect, a motor unit may comprise a motor comprising a stator coil; a motor busbar connected to the stator coil; a first terminal located at a leading end of the motor busbar; a first guide member fixed to the first terminal and comprising a first guide surface; a second terminal fastened to the first terminal with a bolt and comprising a contact surface for contact with the first terminal; a terminal block holding the second terminal; and a second guide member fixed to the second terminal and comprising a second guide surface. The first guide surface and the second guide surface may be configured to come into contact with each other as the first terminal approaches the second terminal in a direction parallel to the contact surface. Each of the first guide surface and the second guide surface may comprise a first profile that prohibits contact between the first terminal and the second terminal at least when the first terminal and the second terminal begin to face each other.

In the motor unit described above, when the first terminal approaches the second terminal in a direction parallel to the contact surface, the first guide surface of the first guide member and the second guide surface of the second guide member come into contact with each other. The first guide member is fixed to the first terminal, and the second guide member is fixed to the second terminal. Therefore, the first terminal and the second terminal move apart from each other or move toward each other in response to how the profiles (surface shapes) of the first guide surface and the second guide surface contact each other. In particular, each of the first guide surface and the second guide surface includes the first profile that prevents contact between the first terminal and the second terminal at least when the first terminal and the second terminal begin to face each other. Therefore, when the first terminal approaches the second terminal in a direction parallel to the contact surface, relative sliding between the first terminal and the second terminal can be at least partially avoided. Thus, the generation of conductive particles from the first terminal and/or the second terminal can be prevented or suppressed.

In a second aspect according to the first aspect, the first profile of the first guide surface may comprise a convex shape protruding toward the second guide surface, and the first profile of the second guide surface may comprise a convex shape protruding toward the first guide surface. In this configuration, the first terminal is guided away from the second terminal by the convex shape of the second guide surface, and the second terminal is guided away from the first terminal by the convex shape of the first guide surface. Thus, when the terminals reach positions where they face each other, contact between the first terminal and the second terminal is avoided.

In a third aspect according to the above first or second aspect, each of the first guide surface and the second guide surface may comprise a second profile that permits contact between the first terminal and the second terminal when the first terminal reaches a position where the first terminal is to be fastened to the second terminal as a result of approaching the second terminal in the direction parallel to the contact surface. In this configuration, when the first terminal reaches the position where it is to be fastened to the second terminal, the first terminal and the second terminal can come into contact with each other without being hindered by the first guide member and the second guide member.

In a fourth aspect according to the above third aspect, the second profile of the first guide surface may comprise a concave shape configured to receive the convex shape of the second guide surface, and the second profile of the second guide surface may comprise a concave shape configured to receive the convex shape of the first guide surface. In this configuration, when the first terminal reaches the position where it is to be fastened to the second terminal, the convex shape of the first guide surface is housed in the concave shape of the second guide surface, and the convex shape of the second guide surface is housed in the concave shape of the first guide surface, thereby allowing the first terminal and the second terminal to come into contact with each other.

In a fifth aspect according to any of the above first to fourth aspects, at least one of the first guide member and the second guide member may be constituted of a resin material. In this configuration, no conductive particles are generated due to contact between the first guide member and the second guide member.

### First Embodiment

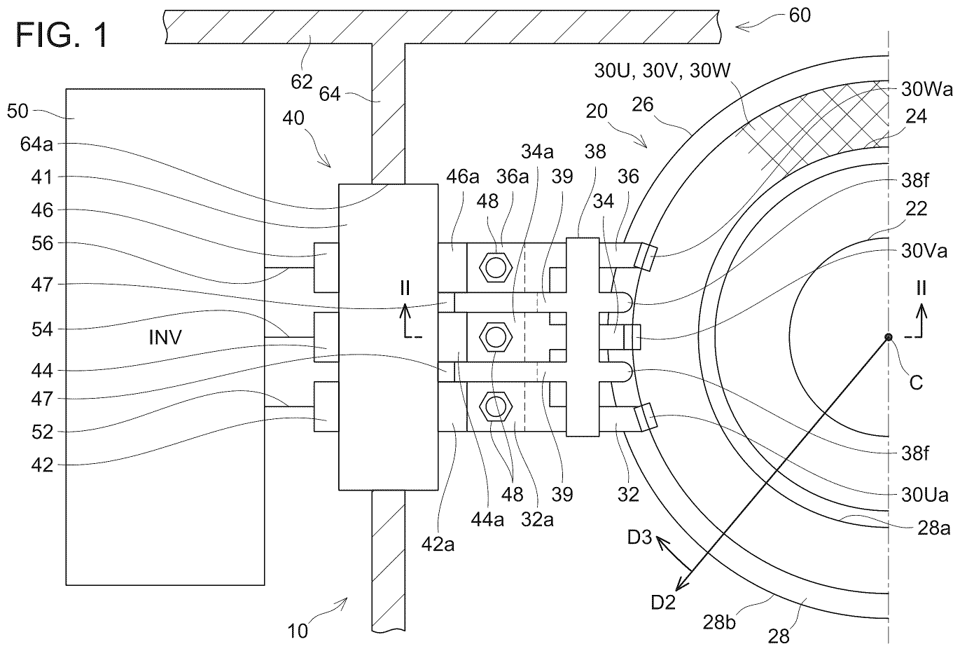

Referring to FIGS. 1 to 5, a motor unit 10 according to an embodiment is described. As shown in FIG. 1, the motor unit 10 constitutes, together with an inverter 50, a drive system mounted on an electric vehicle. The motor unit 10 includes a motor 20. The motor 20 is a traction motor for the electric vehicle and serves as a prime mover configured to drive at least one wheel of the electric vehicle. The motor 20 is, for example, a three-phase motor. The motor unit 10 can be supplied with power from a battery via the inverter 50.

The inverter 50 electrically connects the battery mounted on the electric vehicle to the motor unit 10. The inverter 50 converts direct current power supplied from the battery into three-phase alternating current power. The inverter 50 includes multiple inverter busbars 52, 54, and 56. The inverter 50 can transfer current power to and from the motor unit 10 via the multiple inverter busbars 52, 54, and 56. The multiple inverter busbars 52, 54, and 56 include a U-phase inverter busbar 52, a V-phase inverter busbar 54, and a W-phase inverter busbar 56. In FIG. 1, the multiple inverter busbars 52, 54, and 56 are simply illustrated as straight lines.

The motor unit 10 and the inverter 50 are housed in a common casing 60. However, the motor unit 10 and the inverter 50 are not limited to being housed in the common casing 60 and may be housed in separate casings. The casing 60 is a housing member. The casing 60 includes a casing body 62 and a partition wall 64 separating the motor 20 from the inverter 50 within the casing body 62.

The motor 20 includes a shaft 22, a rotor 24, and a stator 26. The shaft 22 extends along a central axis C of the motor 20. The rotor 24 is a substantially cylindrical member. The rotor 24 is fixed to the shaft 22. The rotor 24 rotates with the shaft 22 about the central axis C.

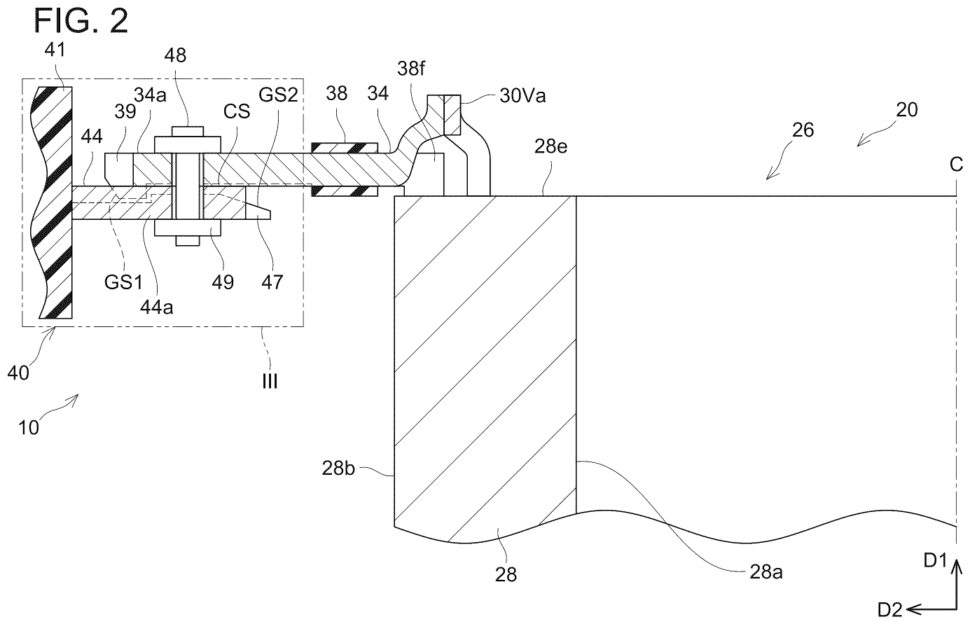

In the disclosure herein, a cylindrical coordinate system comprising an axial direction, a radial direction, and a circumferential direction is defined with respect to the central axis C of the motor 20. The axial direction is the direction parallel to the central axis C and is defined by a coordinate axis D1 parallel to the central axis C (see FIG. 2). In the disclosure herein, the positive direction of the coordinate axis D1 may be expressed as one side of the axial direction. The negative direction of the coordinate axis D1 may be expressed as the other side of the axial direction. The radial direction is a direction perpendicular to the central axis C and is defined by a coordinate axis D2 with the central axis C as the origin (see FIG. 1). In the disclosure herein, the positive direction of the coordinate axis D2 may be expressed as the outer side of the radial direction, and the negative direction of the coordinate axis D2 may be expressed as the inner side of the radial direction. The circumferential direction is the direction perpendicular to both the axial direction and the radial direction and defined by a coordinate axis D3 that extends around the central axis C (see FIG. 1). In the disclosure herein, the positive direction of the coordinate axis D3 may be expressed as one side of the circumferential direction, and the negative direction of the coordinate axis D3 may be expressed as the other side of the circumferential direction.

The stator 26 is a substantially cylindrical member. The stator 26 is disposed radially outward of the rotor 24. The stator 26 includes a stator core 28 and multiple coils 30U, 30V, and 30W. Three-phase alternating current power of U, V, and W phases is output from the inverter 50 to the multiple coils 30 of the stator 26, thereby causing the rotor 24 and the shaft 22 of the motor 20 to rotate.

FIG. 2 shows a cross-sectional view of the motor unit 10, with the rotor 24 and the shaft 22 omitted. The stator core 28 is a cylindrical member. The stator core 28 has one end surface 28e located on the one side of the axial direction and the other end surface (not shown) located on the other side of the axial direction. The stator core 28 extends from the one end surface 28e to the other end surface along the axial direction. The stator core 28 includes an inner circumferential surface 28a. The inner circumferential surface 28a is the radially inward surface of the stator core 28 and extends cylindrically along the circumferential direction. The inner circumferential surface 28a of the stator core 28 defines a through hole that houses at least a portion of the rotor 24. The inner circumferential surface 28a of the stator core 28 includes multiple slots (not shown) arranged along the circumferential direction. An outer circumferential surface 28b of the stator core 28 is the radially outward surface of the stator core 28 and extends cylindrically along the circumferential direction. The inner circumferential surface 28a and the outer circumferential surface 28b extend in the axial direction between the one end surface 28e and the other end surface (not shown).

The multiple coils 30U, 30V, and 30W are arranged in the slots of the stator core 28. Specifically, each of the multiple stator coils 30U, 30V, and 30W is arranged across two or more slots. Each of the stator coils 30U, 30V, and 30W is a segment coil formed of a conductor wire having a rectangular cross-section. The specific configuration of each of the multiple coils 30U, 30V, and 30W is not particularly limited. For example, each of the multiple coils 30U, 30V, and 30W may have a concentrated winding configuration or a distributed winding configuration.

The multiple coils 30U, 30V, and 30W include a U-phase coil 30U, a V-phase coil 30V, and a W-phase coil 30W. The U-phase coil 30U includes one end 30Ua on the input/output side and the other end (not shown) on the neutral point side. The V-phase coil 30V has one end 30Va on the input/output side and the other end (not shown) on the neutral point side. The W-phase coil 30W has one end 30Wa on the input/output side and the other end (not shown) on the neutral point side. The other ends of the coils 30U, 30V, and 30W are electrically connected to each other and form the neutral point in a Y-connection. That is, the motor 20 in this embodiment is a Y-connection type motor. As shown in FIG. 2, the one ends 30Ua, 30Va, and 30Wa of the coils 30U, 30V, and 30W protrude from the one end surface 28e of the stator core 28 toward the one side of the axial direction (i.e., upward in FIG. 2).

The motor unit 10 includes, in addition to the above-described motor 20, multiple motor busbars 32, 34, 36, a busbar holder 38, multiple first guide members 39, a terminal block 40, and multiple second guide members 47.

Each of the multiple motor busbars 32, 34, and 36 is a plate-shaped member and formed using a conductive material such as metal. The multiple motor busbars 32, 34, and 36 include a U-phase motor busbar 32, a V-phase motor busbar 34, and a W-phase motor busbar 36. The U-phase motor busbar 32 is connected to the one end 30Ua of the U-phase coil 30U. The V-phase motor busbar 34 is connected to the one end 30Va of the V-phase coil 30V. The W-phase motor busbar 36 is connected to the one end 30Wa of the W-phase coil 30W.

Each of the motor busbars 32, 34, and 36 has a leading end and a base end connected to corresponding one of the coils 30U, 30V, or 30W and extends between the leading end and the base end. The multiple motor busbars 32, 34, and 36 include first terminals 32a, 34a, and 36a, respectively, and the first terminals 32a, 34a, and 36a have a flat-plate shape and are located at the leading ends of the corresponding motor busbars. That is, the first terminals 32a, 34a, and 36a include a U-phase first terminal 32a, a V-phase first terminal 34a, and a W-phase first terminal 36a. The first terminals 32a, 34a, and 36a each extend along a planar direction perpendicular to the axial direction.

The busbar holder 38 is a holding member to hold the multiple motor busbars 32, 34, and 36. The busbar holder 38 is constituted of, for example, a resin material. The busbar holder 38 includes multiple fixation portions 38f. The busbar holder 38 is fixed to the one end surface 28e of the stator core 28 at the multiple fixation portions 38f. The busbar holder 38 may be fastened to the stator core 28 using multiple fastener members such as bolts, although this is merely an example.

The first terminals 32a, 34a, and 36a are attached to the terminal block 40. In this embodiment, the terminal block 40 is fixed to a through hole 64a formed in the partition wall 64 of the casing 60. The terminal block 40 includes a base 41 and multiple terminal block busbars 42, 44, and 46 held by the base 41. The base 41 is constituted of an insulating material such as a resin material. Each of the multiple terminal busbars 42, 44, and 46 is a plate-shaped member and formed using a conductive material such as metal.

Each of the terminal block busbars 42, 44, and 46 has a base end and a leading end and extends between the base end and the leading end. Each of the base ends of the terminal block busbars 42, 44, and 46 is connected to corresponding one of the inverter busbars 52, 54, and 56. The terminal block busbars 42, 44, and 46 include second terminals 42a, 44a, and 46a, respectively, and the second terminals 42a, 44a, and 46a have a flat-plate shape and are located at the leading ends of the terminal block busbars. That is, the second terminals 42a, 44a, and 46a include a U-phase second terminal 42a, a V-phase second terminal 44a, and a W-phase second terminal 46a. As an example, the multiple terminal block busbars 42, 44, and 46 are held by the base 41 of the terminal block 40 at their second terminals 42a, 44a, and 44b. The second terminals 42a, 44a, and 46a extend along the first terminals 32a, 34a, and 36a, respectively.

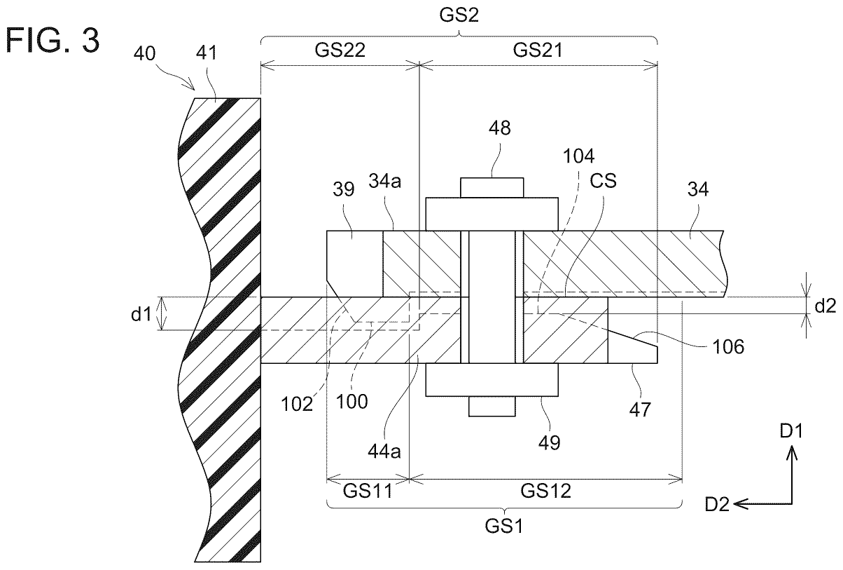

Referring now to FIGS. 2 and 3, the configurations of the first terminals 32a, 34a, and 36a and the second terminals 42a, 44a, and 46a are described. In FIGS. 2 and 3, only the V-phase first terminal 34a and the V-phase second terminal 44a are illustrated. The V-phase second terminal 44a is arranged parallel to the V-phase first terminal 34a. The V-phase second terminal 44a includes a contact surface CS configured to contact the V-phase first terminal 34a. The V-phase second terminal 44a is fastened to the V-phase first terminal 34a at the contact surface CS via a bolt 48. The bolt 48 extends through the V-phase first terminal 34a and the V-phase second terminal 44a and is coupled to a nut 49 fixed to the V-phase second terminal 44a, so that the V-phase first terminal 34a and the V-phase second terminal 44a are fastened together. Although not shown in FIG. 2, the U-phase first terminal 32a and the U-phase second terminal 42a, as well as the W-phase first terminal 36a and the W-phase second terminal 46a, may have the same configurations as the V-phase first terminal 34a and the V-phase second terminal 44a. The U-phase second terminal 42a includes a contact surface configured to contact the U-phase first terminal 32a of the U-phase motor busbar 32 and is fastened to the U-phase first terminal 32a at the contact surface via a bolt 48. The W-phase second terminal 46a includes a contact surface configured to contact the W-phase first terminal 36a of the W-phase motor busbar 36 and is fastened to the W-phase first terminal 36a at the contact surface via a bolt 48. That is, the second terminals 42a, 44a, and 46a of the terminal block busbars 42, 44, and 46 are connected to the first terminals 32a, 34a, and 36a of the motor busbars 32, 34, and 36, respectively.

The multiple first guide members 39 are configured to guide the first terminals 32a, 34a, and 36a when the first terminals 32a, 34a, and 36a of the motor busbars 32, 34, and 36 are connected to the second terminals 42a, 44a, and 46a on the terminal block 40, respectively. Each of the multiple first guide members 39 is fixed to one or more of the multiple first terminals 32a, 34a, and 36a. As an example, the motor unit 10 according to this embodiment includes two first guide members 39. One of the two first guide members 39 is positioned between the U-phase first terminal 32a and the V-phase first terminal 34a and is fixed to both the U-phase first terminal 32a and the V-phase first terminal 34a. The other of the two first guide members 39 is positioned between the V-phase first terminal 34a and the W-phase first terminal 36a and is fixed to both the V-phase first terminal 34a and the W-phase first terminal 36a. The number of first guide members 39 is not limited to two and may be one or three or more. The number of the first guide members 39 may be any number as long as each first guide member 39 is configured to guide at least one of the first terminals 32a, 34a, and 36a. As an example, each first guide member 39 is formed using an insulating material such as a resin material. The first guide members 39 are integrally formed with the busbar holder 38. In a modification, the first guide members 39 may be formed separately from the busbar holder 38.

The multiple second guide members 47 are configured to come into contact with the multiple first guide members 39 when the first terminals 32a, 34a, and 36a of the motor busbars 32, 34, and 36 are connected to the second terminals 42a, 44a, and 46a on the terminal block 40, respectively. Each of the multiple second guide members 47 is fixed to one or more of the second terminals 42a, 44a, and 46a. As an example, the motor unit 10 according to this embodiment includes two second guide members 47. One of the two second guide members 47 is positioned between the U-phase second terminal 42a and the V-phase second terminal 44a and is fixed to both the U-phase second terminal 42a and the V-phase second terminal 44a. The other of the two second guide members 47 is positioned between the V-phase second terminal 44a and the W-phase second terminal 46a and is fixed to both the V-phase second terminal 44a and the W-phase second terminal 46a. The number of the second guide members 47 is not limited to two and may be one or three or more. The number of the second guide members 47 may be any number as long as each second guide member 47 is configured to guide at least one of the second terminals 42a, 44a, and 46a. As an example, the second guide members 47 are formed using an insulating material such as a resin material. The second guide members 47 are integrally formed with the base 41 of the terminal block 40. In a modification, the second guide members 47 may be formed separately from the base 41 of the terminal block 40.

Each first guide member 39 includes a first guide surface GS1. Each second guide member 47 includes a second guide surface GS2. In FIGS. 2 and 3, only the other of the two first guide members 39 and the other of the two second guide members 47 are shown. The two first guide members 39 may have the same configuration, and the two second guide members 47 may have the same configuration.

As shown in FIG. 3, the first guide surface GS1 has a convex shape GS11 and a concave shape GS12. The convex shape GS11 is located on the leading end side of the first guide member 39, and the concave shape GS12 is located on the base end side of the first guide member 39. The convex shape GS11 protrudes toward the second guide surface GS2. The convex shape GS11 is an example of the first profile in the present technology. The convex shape GS11 includes a top surface 100 and a tapered surface 102. The top surface 100 is flat surface and extends parallel to the longitudinal direction of the V-phase first terminal 34a. The tapered surface 102 extends from the top surface 100 toward the leading end of the first guide member 39. The height of the convex shape GS11 gradually decreases toward the leading end of the first guide member 39 along the tapered surface 102. The tapered surface 102 may be a flat surface or curved surface. The concave shape GS12 refers to a portion that is concave relative to the convex shape GS11. The concave shape GS12 is a flat surface and extends parallel to the longitudinal direction of the V-phase first terminal 34a. The concave shape GS12 is an example of the second profile in the present technology.

The second guide surface GS2 includes a convex shape GS21 and a concave shape GS22. The convex shape GS21 is located at the leading end side of the second guide member 47, and the concave shape GS22 is located at the base end side of the second guide member 47. The convex shape GS21 protrudes toward the first guide surface GS1. The convex shape GS21 is an example of the first profile in the present technology. The convex shape GS11 includes a top surface 104 and a tapered surface 106. The top surface 104 is a flat surface and extends parallel to the longitudinal direction of the second terminal 44a. The tapered surface 106 extends from the top surface 104 toward the leading end of the second guide member 47. The height of the convex shape GS21 gradually decreases toward the leading end of the second guide member 47 along the tapered surface 106. The tapered surface 106 may be a flat surface or a curved surface. The concave shape GS22 refers to a portion that is concave relative to the convex shape GS21. The concave shape GS22 is a flat surface and extends parallel to the longitudinal direction of the second terminal 44a. The concave shape GS22 is an example of the second profile in the present technology.

In the state where the first terminals 32a, 34a, and 36a are connected to the second terminals 42a, 44a, and 46a, respectively, the convex shape GS11 of each first guide surface GS1 faces the concave shape GS22 of corresponding second guide surface GS2, and the concave shape GS12 of each first guide surface GS1 faces the convex shape GS21 of corresponding second guide surface GS2. In this state, the convex shapes GS11 of the first guide surfaces GS1 and the concave shapes GS22 of the second guide surfaces GS2 are not in contact with each other. That is, there are spaces between the convex shapes GS11 and the concave shapes GS22. Similarly, in the above state, the concave shapes GS12 of the first guide surfaces GS1 and the convex shapes GS21 of the second guide surfaces GS2 are not in contact with each other. That is, there are spaces between the concave shapes GS12 and the convex shapes GS21.

As shown in FIG. 3, the convex shape GS11 of the first guide member 39 protrudes in the direction perpendicular to the contact surface CS by a dimension d1 relative to the surface of the V-phase first terminal 34a. The convex shape GS21 of the second guide member 47 is recessed by a dimension d2 relative to the surface of the V-phase second terminal 44a. It is preferable that the dimension d1 by which the convex shape GS11 of the first guide member 39 protrudes is larger than the dimension d2 by which the convex shape GS21 of the second guide member 47 is recessed. As will be described in detail later, this relationship allows for avoidance of unnecessary contact between the V-phase first terminal 34a and the V-phase second terminal 44a during connection of the V-phase first terminal 34a to the V-phase second terminal 44a.

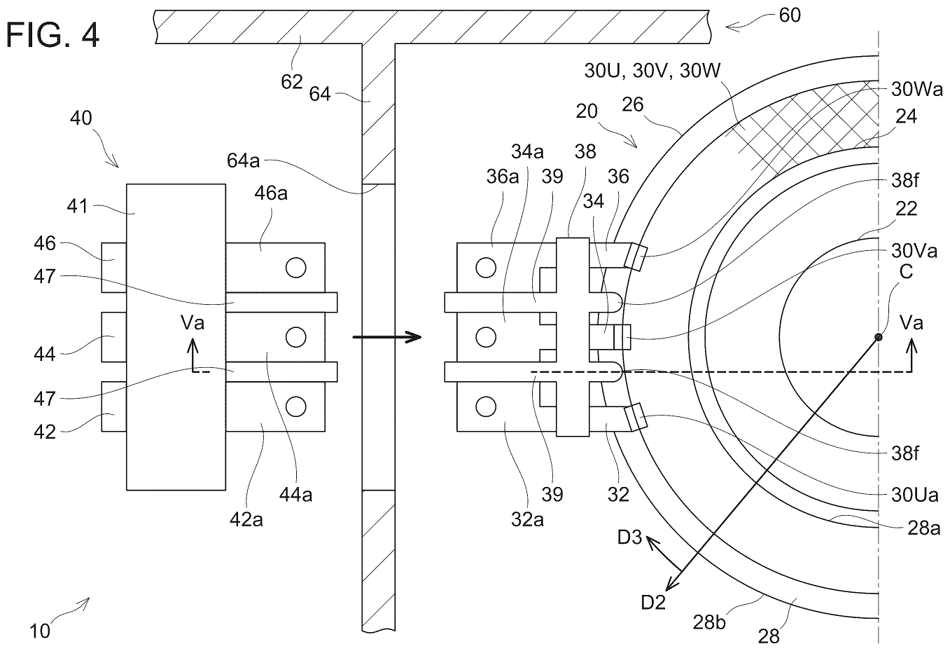

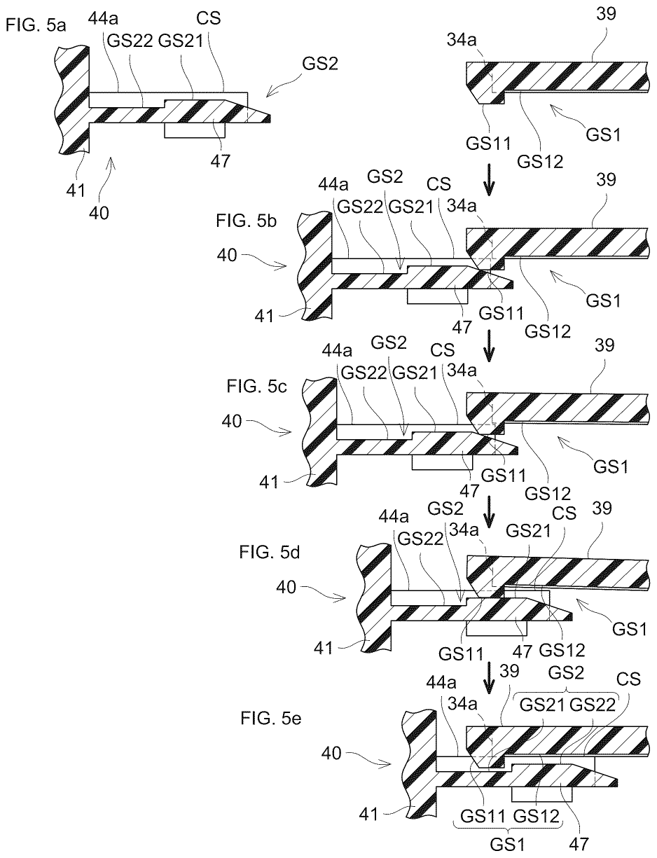

Next, referring to FIGS. 4 and 5(a) to 5(e), how the first terminals 32a, 34a, and 36a are connected to the second terminals 42a, 44a, and 46a is described. In FIGS. 4 and 5(a) to 5(e), the V-phase first terminal 34a and the V-phase second terminal 44a are shown as representatives of the first and second terminals. Hereinafter, the V-phase first terminal 34a and the V-phase second terminal 44a are used as examples, but the same applies to all the first terminals 32a, 34a, and 36a and all the second terminals 42a, 44a, and 46a.

As shown in FIG. 4, during manufacture of the motor unit 10, the terminal block 40 is inserted into the through hole 64a of the casing 60. At this time, the motor 20 is already mounted in the casing 60, and the first terminals 32a, 34a, and 36a of the motor 20 are already inside the casing 60. As shown in FIG. 5(a) to 5(b), during the insertion of the terminal block 40 into the through hole 64a of the casing 60, the V-phase first terminal 34a and the V-phase second terminal 44a approach each other in a direction parallel to the contact surface CS. The first guide surface GS1 and the second guide surface GS2 begin to contact each other before the V-phase first terminal 34a and the V-phase second terminal 44a come into contact with each other. Subsequently, as shown in FIG. 5(c), the V-phase first terminal 34a and the V-phase second terminal 44a begin to face each other in the direction perpendicular to the contact surface CS. At this time, the convex shape GS11 of the first guide surface GS1 (particularly the tapered surface 102 shown in FIG. 3) comes into contact with the convex shape GS21 of the second guide surface GS2 (particularly the tapered surface 106 shown in FIG. 3), causing the first guide member 39 and the second guide member 47 to move away from each other. Thus, the V-phase first terminal 34a fixed to the first guide member 39 and the V-phase second terminal 44a fixed to the second guide member 47 are also guided to move away from each other. That is, at this stage, contact between the V-phase first terminal 34a and the V-phase second terminal 44a is prevented.

Subsequently, as shown in FIG. 5(d), the first guide surface GS1 and the second guide surface GS2 slide against each other at the top surfaces 100 and 104 (see FIG. 3) of their convex shapes GS11 and GS21. Even while the first guide surface GS1 and the second guide surface GS2 are sliding against each other, the V-phase first terminal 34a and the V-phase second terminal 44a remain separated from each other. Subsequently, as shown in FIG. 5(e), the V-phase first terminal 34a reaches the position where it is to be fastened to the V-phase second terminal 44a on the terminal block 40. Once the V-phase first terminal 34a has reached the position where it is to be fastened to the V-phase second terminal 44a, the convex portion GS11 of the first guide surface GS1 is housed in the concave portion GS22 of the second guide surface GS2, and the convex shape GS21 of the second guide surface GS2 is also housed in the concave shape GS12 of the first guide surface GS1. Thereby, the V-phase first terminal 34a and the V-phase second terminal 44a come into contact with each other.

As described above, in the motor unit 10 according to this embodiment, as the V-phase first terminal 34a (or the U-phase first terminal 32a or the W-phase first terminal 36a) approaches the V-phase second terminal 44a (or the U-phase second terminal 42a or the W-phase second terminal 46a) in a direction parallel to the contact surface CS, the first guide surface GS1 of the first guide member 39 (one or the other of the two first guide members 39) comes into contact with the second guide surface GS2 of the second guide member 47 (one or the other of the two second guide members 47). The first guide member 39 is fixed to the V-phase first terminal 34a, and the second guide member 47 is fixed to the V-phase second terminal 44a. Thus, the V-phase first terminal 34a and the V-phase second terminal 44a move apart from each other or move toward each other in response to how the profiles (i.e., the convex shapes GS11 and GS21) of the first guide surface GS1 and the second guide surface GS2 contact. In particular, each of the first guide surface GS1 and the second guide surface GS2 includes a first profile that prevents contact between the V-phase first terminal 34a and the V-phase second terminal 44a when the V-phase first terminal 34a and the V-phase second terminal 44a begin to face each other. Thus, when the V-phase first terminal 34a approaches the V-phase second terminal 44a in a direction parallel to the contact surface CS, sliding between the V-phase first terminal 34a and the V-phase second terminal 44a is at least partially avoided. Therefore, the generation of conductive particles from the V-phase first terminal 34a and/or the V-phase second terminal 44a is prevented or suppressed.

Furthermore, in this embodiment, the first guide surface GS1 includes the convex shape GS11 protruding toward the second guide surface GS2 as a first profile. Further, the second guide surface GS2 includes the convex shape GS21 protruding toward the first guide surface GS1 as a first profile. According to this configuration, the V-phase first terminal 34a is guided away from the V-phase second terminal 44a by the convex shape GS21 of the second guide surface GS2, and the V-phase second terminal 44a is guided away from the V-phase first terminal 34a by the convex shape GS11 of the first guide surface GS1. Thus, when the V-phase first terminal 34a and the V-phase second terminal 44a reach positions where they face each other, contact between the V-phase first terminal 34a and the V-phase second terminal 44a is avoided. The first profile (here, the convex shape GS11) of the first guide surface GS1 and the first profile (here, the convex shape GS21) of the second guide surface GS2 work cooperatively to guide the terminals. Therefore, it is preferable that the first profile of the first guide surface GS1 and the first profile of the second guide surface GS2 are designed collectively.

Furthermore, in this embodiment, the first guide surface GS1 and the second guide surface GS2 include the concave shapes GS12 and GS22, respectively, as second profiles. When the V-phase first terminal 34a reaches the position where it is to be fastened to the V-phase second terminal 44a, the concave shapes GS12 and GS22 house the convex shapes GS21 and GS11, respectively, thereby allowing contact between the V-phase first terminal 34a and the V-phase second terminal 44a. In this configuration, when the V-phase first terminal 34a reaches the position where it is to be fastened to the V-phase second terminal 44a, the V-phase first terminal 34a and the V-phase second terminal 44a can come into contact with each other without being hindered by the first guide member 39 and the second guide member 47.

The above description has been provided using the combination of the V-phase first terminal 34a and the V-phase second terminal 44a as an example, however, the same applies to the combination of the U-phase first terminal 32a and the U-phase second terminal 42a and the combination of the W-phase first terminal 36a and the W-phase second terminal 46a. That is, the U-phase first terminal 32a, the V-phase first terminal 34a, and the W-phase first terminal 36a are examples of “first terminal” according to the present technology, and the U-phase second terminal 42a, the V-phase second terminal 44a, and the W-phase second terminal 46a are examples of “second terminal” according to the present technology.

In this embodiment, the first guide members 39 and the second guide members 47 are constituted of a resin material. In this configuration, no conductive particles are generated due to contact between the first guide members 39 and the second guide members 47. In a modification, either the first guide members 39 or the second guide members 47 may be constituted of a resin material. In another modification, neither the first guide members 39 nor the second guide members 47 may be constituted of a resin material. For example, the first guide members 39 and the second guide members 47 may be constituted of a conductive material such as metal.

In this embodiment, the hardness of the resin material forming the first guide members 39 is lower than the hardness of the resin material forming the second guide member 47. That is, the first guide members 39 are more flexible (i.e., more prone to elastic deformation) than the second guide member 47. Therefore, for fastening the first terminals 32a, 34a, and 36a to the second terminals 42a, 44a, and 46a, respectively, the first terminals 32a, 34a, and 36a can be easily guided to the positions where they are to be fastened to the second terminals 42a, 44a, and 46a, regardless of manufacturing errors in clearances between the first terminals 32a, 34a, and 36a and the second terminals 42a, 44a, and 46a. In a modification, the hardness of the resin material forming the second guide members 47 may be lower than the hardness of the resin material forming the first guide member 39. In another modification, the hardness of the resin material forming the first guide members 39 may be substantially equal to the hardness of the resin material forming the second guide members 47.

### Second Embodiment

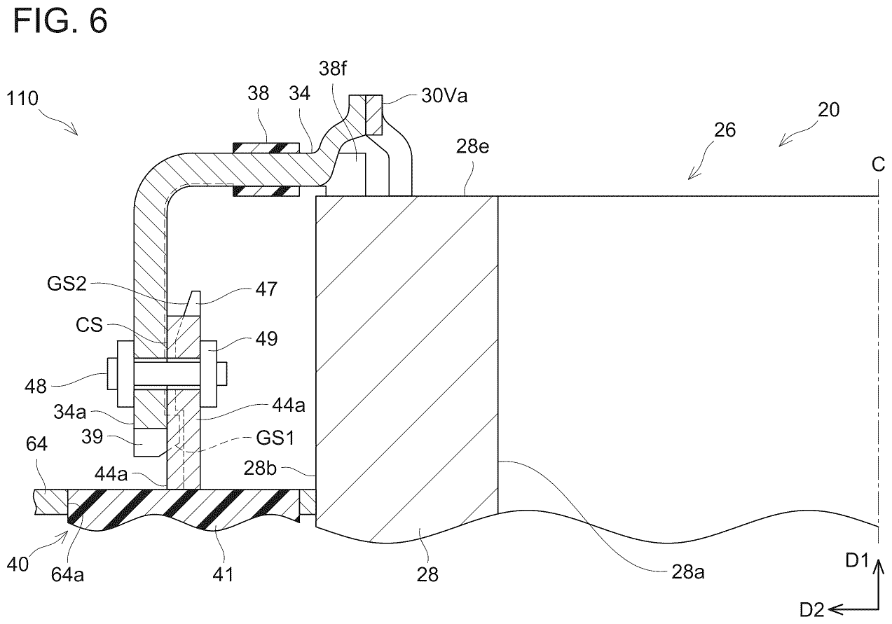

Referring to FIG. 6, a motor unit 110 according to an embodiment is described. In the motor unit 110 according to this embodiment, the position and orientation of the terminal block 40 are different compared to the motor unit 10 according to the first embodiment. In addition, the shapes of the motor busbars 32, 34, and 36 are also different accordingly. In FIG. 6, elements that are the same as or corresponding to the elements of the motor unit 10 according to the first embodiment are labeled with the same reference signs. Hereinafter, only differences between the motor unit 110 according to this embodiment and the motor unit 10 according to the first embodiment are described.

As shown in FIG. 6, in the motor unit 110 according to this embodiment, the terminal block 40 is arranged radially outward of the motor 20, and the second terminals 42a, 44a, and 46a extend toward the one side of the axial direction. Additionally, the first terminals 32a, 34a, and 36a located at the leading ends of the motor busbars 32, 34, and 36 extend toward the other side of the axial direction. Thus, the first terminals 32a, 34a, and 36a and the second terminals 42a, 44a, and 46a approach each other along the axial direction when they are connected to each other. In FIG. 6, only one V-phase motor busbar 34 and its V-phase first terminal 34a are shown among the multiple motor busbars 32, 34, and 36, and only one V-phase second terminal 44a is shown among the multiple second terminals 42a, 44a, and 46a.

In the above configuration, the terminal block 40 can be located in a space that is radially adjacent to the motor 20 and extends in the axial direction. As an example, during manufacture of the motor unit 110 according to this embodiment, the motor 20 can be axially attached to the casing 60 to which the terminal block 40 is already mounted. During the attachment, the first terminals 32a, 34a, and 36a and the second terminals 42a, 44a, and 46a approach each other along the axial direction, thereby connected to each other in the same manner as in FIG. 5. The terminal block 40 can also be inserted along the axial direction into the through holes 64a formed in the casing 60. This configuration allows for a reduction in the size of the motor unit 110 since the motor busbars 32, 34, 36 and the terminal block 40 are arranged radially adjacent to the motor 20. The position of the through hole 64a in the casing 60 is different between the first and second embodiments.

In another embodiment, the assembling order of the motor 20 and terminal block 40 to the casing 60 may be changed. That is, during manufacture of the motor unit 110 according to this embodiment, the terminal block 40 may be axially attached to the casing 60 to which the motor 20 is already attached. In this case as well, the first terminals 32a, 34a, and 36a and the second terminals 42a, 44a, and 46a approach each other along the axial direction, thereby connected to each other in the same manner as shown in FIG. 5.

While specific examples of the present disclosure have been described above in detail, these examples are merely illustrative and place no limitation on the scope of the patent claims. The technology described in the patent claims also encompasses various changes and modifications to the specific examples described above.

In the above first and second embodiments, the motor units 10 and 110 each comprise three first terminals 32a, 34a, and 36a and three second terminals 42a, 44a, and 46a. The number of the first terminals 32a, 34a, 36a and the number of the second terminals 42a, 44a, 46a are not limited to three. In a modification, the motor units 10 and 110 each may further include another first terminal and another second terminal for connecting a charging power source and the neutral points, in addition to the three first terminals 32a, 34a, and 36a and the three second terminals 42a, 44a, and 46a. In another modification, the motor units 10 and 110 each may include additional three first terminals and additional three second terminals for connecting the other ends of the phase coils 30U, 30V, and 30W of the motor 20 to a second inverter, in addition to the three first terminals 32a, 34a, and 36a and the three second terminals 42a, 44a, and 46a for connecting the one ends of the phase coils 30U, 30V, and 30W of the motor 20 to the inverter 50.

In a modification, the motor units 10 and 110 may not comprise the busbar holder 38.

The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A motor unit comprising:
a motor comprising a stator coil;
a motor busbar connected to the stator coil;
a first terminal located at a leading end of the motor busbar;
a first guide member fixed to the first terminal and comprising a first guide surface;
a second terminal fastened to the first terminal with a bolt and comprising a contact surface for contact with the first terminal;
a terminal block holding the second terminal; and
a second guide member fixed to the second terminal and comprising a second guide surface,
wherein the first guide surface and the second guide surface are configured to come into contact with each other as the first terminal approaches the second terminal in a direction parallel to the contact surface, and
each of the first guide surface and the second guide surface comprises a first profile that prohibits contact between the first terminal and the second terminal at least when the first terminal and the second terminal begin to face each other.

2. The motor unit according to claim 1, wherein
the first profile of the first guide surface comprises a convex shape protruding toward the second guide surface, and
the first profile of the second guide surface comprises a convex shape protruding toward the first guide surface.

3. The motor unit according to claim 2, wherein each of the first guide surface and the second guide surface comprises a second profile that permits contact between the first terminal and the second terminal when the first terminal reaches a position where the first terminal is to be fastened to the second terminal as a result of approaching the second terminal in the direction parallel to the contact surface.

4. The motor unit according to claim 3, wherein
the second profile of the first guide surface comprises a concave shape configured to receive the convex shape of the second guide surface, and
the second profile of the second guide surface comprises a concave shape configured to receive the convex shape of the first guide surface.

5. The motor unit according to claim 1, wherein at least one of the first guide member and the second guide member is constituted of a resin material.
